(19) United States
(12) Patent Application Publication
(10) Pub. No.: US 2015/0224398 A1
(43) Pub. Date: Aug. 13, 2015

(54) Social Marketing Systems and Methods

(71) Applicant: Zwittle, Inc., North Logan, UT (US)

(72) Inventors: Scott B. Jensen, North Logan, UT (US); Amy M. Jensen, North Logan, UT (US); David Knight, Hyrum, UT (US); Mike Schaefer, Benson, UT (US)

(73) Assignee: ZWITTLE, INC., North Logan, UT (US)

(21) Appl. No.: 14/177,215

(22) Filed: Feb. 10, 2014

(51) Int. Cl. A63F 13/61; A63F 13/48; A63F 13/35

(52) U.S. Cl. CPC A63F 13/61; A63F 13/35; A63F 13/48

(57) ABSTRACT

Systems and methods for social marketing engage target markets in a game or competition, while marketing is targeted to the participants of the game or competition. The game or competition is designed to initially attract participants who might be interested in the products or services of a particular business. The game or competition is further designed to retain participants who are more likely to be interested in the products or services such that marketing efforts associated with the game or competition are more likely to reach a desirable target audience. The game or competition is designed to require increased engagement from participants over time, thereby narrowing the participant group to those most interested in the products or services associated with the competition. Marketing efforts can be modified over time during the game or competition to target the narrowed field of participants, namely those most interested in the products or services.

### CROSS-REFERENCE TO RELATED APPLICATIONS

This application claims the benefit of U.S. Provisional Application No. 61/762,770, filed Feb. 8, 2013.

### BACKGROUND OF THE INVENTION

1. Field of the Invention

The present invention relates to marketing, and more particularly to systems and methods for social marketing.

2. Background and Related Art

One of the major challenges for a business is to properly direct its marketing efforts. For example, it can be difficult to ensure that marketing successfully reaches those individuals and businesses most likely to need and want products or services that are the subject of marketing. Marketing efforts can fail, be wasteful, or are simply not as effective as they could possibly be if they target too broad an audience, target too narrow an audience, or target the wrong audience. Businesses can fail due to ineffective marketing efforts.

### BRIEF SUMMARY OF THE INVENTION

Implementation of the invention provides systems and methods for social marketing that engage target markets in a game or competition, and then permit targeted marketing to the participants of the game or competition. The game or competition is designed to initially attract participants who might be interested in the products or services of a particular business. The game or competition is further designed to engage, over a period of time, participants who are more likely to be interested in the products or services such that marketing efforts associated with the game or competition are more likely to reach a desirable target audience. The game or competition is designed to encourage and require increased engagement from participants over time, thereby focusing and narrowing the participant group to those most interested in the products or services associated with the competition.

Marketing efforts associated with the game or competition can be modified over time during the game or competition as the base of participants is narrowed to those most interested in the products or services. Thus, for example, marketing efforts might initially be crafted to engage a broader target audience, and may be modified as the game or competition progresses to match the expected interests of the ever narrower group participants that are still engaged as the game progresses. By the time the game or competition results in one or more winners, marketing efforts have been successfully delivered to desired target audiences most likely to be interested in the products or services of a business or businesses associated with the game or competition.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 illustrates a representative computer system for use with embodiments of the invention;

FIG. 2 illustrates a representative networked computer system for use with embodiments of the invention;

FIGS. 3-5 illustrate representative browser windows for use with embodiments of the invention; and

FIGS. 6-8 provide conceptual illustrations of concepts associated with marketing using an online competition format.

The accompanying drawings and images illustrate examples and features of embodiments of the invention. The accompanying drawings and images, as well as the accompanying description discussing the drawings and images are incorporated herein by reference as if set forth in their entirety.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide systems and methods for social marketing that engage target markets in a game or competition, and then permit targeted marketing to the participants of the game or competition. The game or competition may or may not be a free game or competition. The game or competition is designed to initially attract participants who might be interested in the products or services of a particular business. The game or competition is further designed to engage, over a period of time, participants who are more likely to be interested in the products or services such that marketing efforts associated with the game or competition are more likely to reach a desirable target audience. The game or competition is designed to encourage and require increased engagement from participants over time, thereby focusing and narrowing the participant group to those most interested in the products or services associated with the competition.

Marketing efforts associated with the game or competition can be modified over time during the game or competition as the base of participants is narrowed to those most interested in the products or services. Thus, for example, marketing efforts might initially be crafted to engage a broader target audience, and may be modified as the game or competition progresses to match the expected interests of the ever narrower group participants that are still engaged as the game progresses. By the time the game or competition results in one or more winners, marketing efforts have been successfully delivered to desired target audiences most likely to be interested in the products or services of a business or businesses associated with the game or competition.

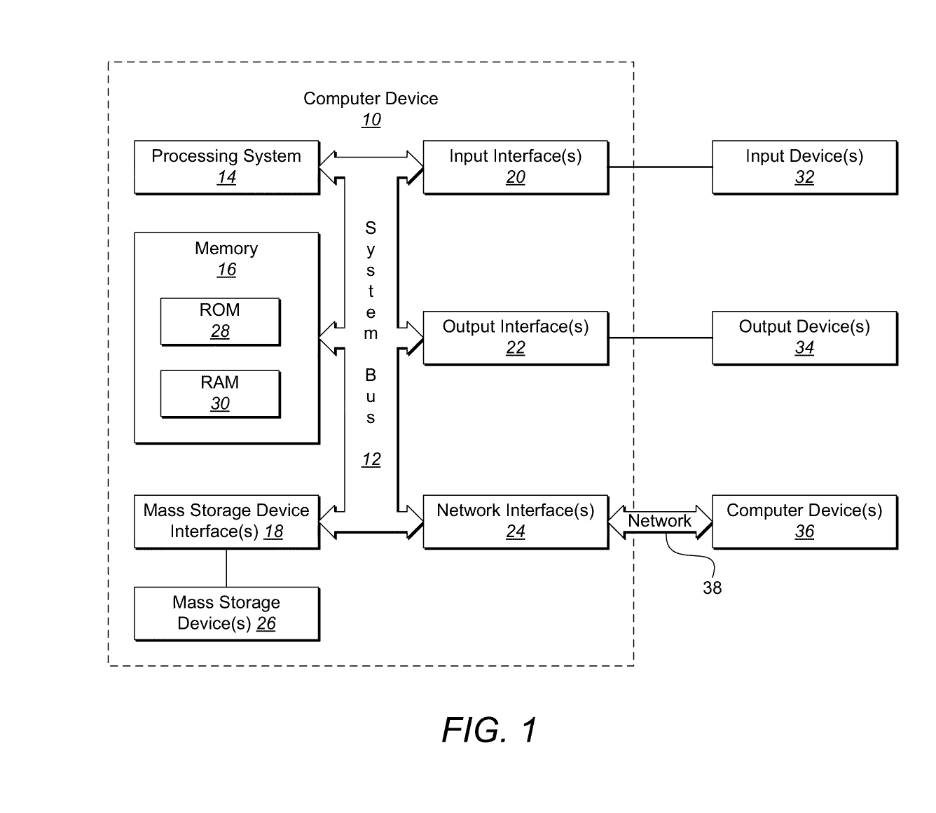

As embodiments of the invention are practiced using computer systems, including networked computer systems, FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand-alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook computer, a netbook, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, a touch screen, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

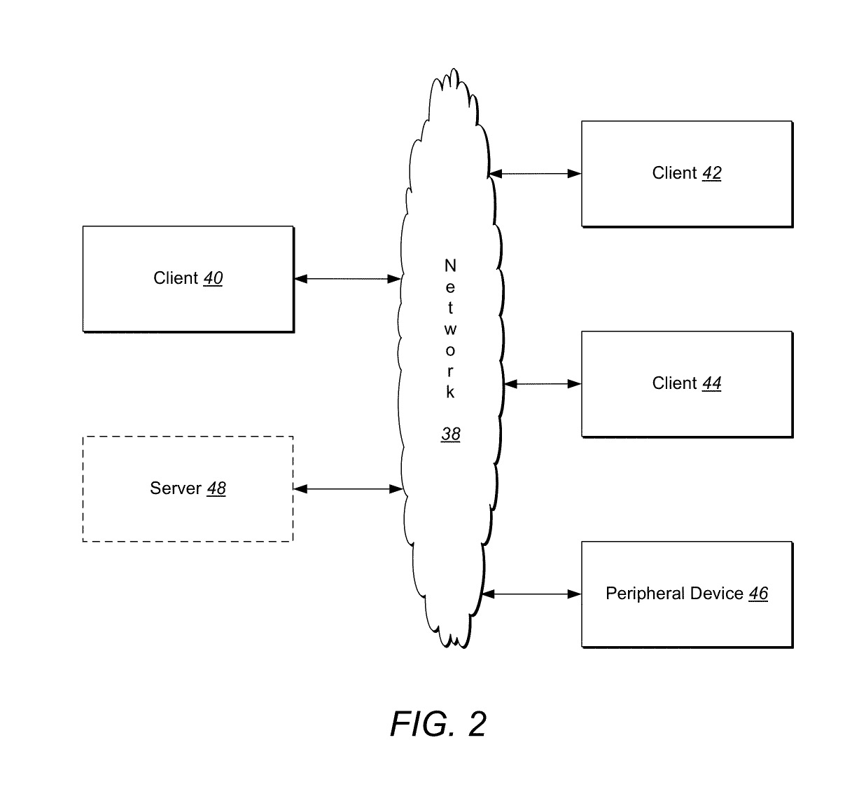

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices 46 across network 38. While FIG. 2 illustrates an embodiment that includes a client 40, two additional clients, client 42 and client 44, one peripheral device 46, and optionally a server 48, connected to network 38, alternative embodiments include more or fewer clients, more than one peripheral device 46, no peripheral devices 46, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Similarly, embodiments of the invention embrace cloud-based architectures where one or more computer functions are performed by remote computer systems and devices at the request of a local computer device. Thus, returning to FIG. 2, the client 40 may be a computer device having a limited set of hardware and/or software resources. Because the client 40 is connected to the network 38, it may be able to access hardware and/or software resources provided across the network 38 by other computer devices and resources, such as client 42, client 44, server 48, or any other resources. The client 40 may access these resources through an access program, such as a web browser, and the results of any computer functions or resources may be delivered through the access program to the user of the client 40. In such configurations, the client 40 may be any type of computer device or electronic device discussed above or known to the world of cloud computing, including traditional desktop and laptop computers, smart phones and other smart devices, tablet computers, or any other device able to provide access to remote computing resources through an access program such as a browser.

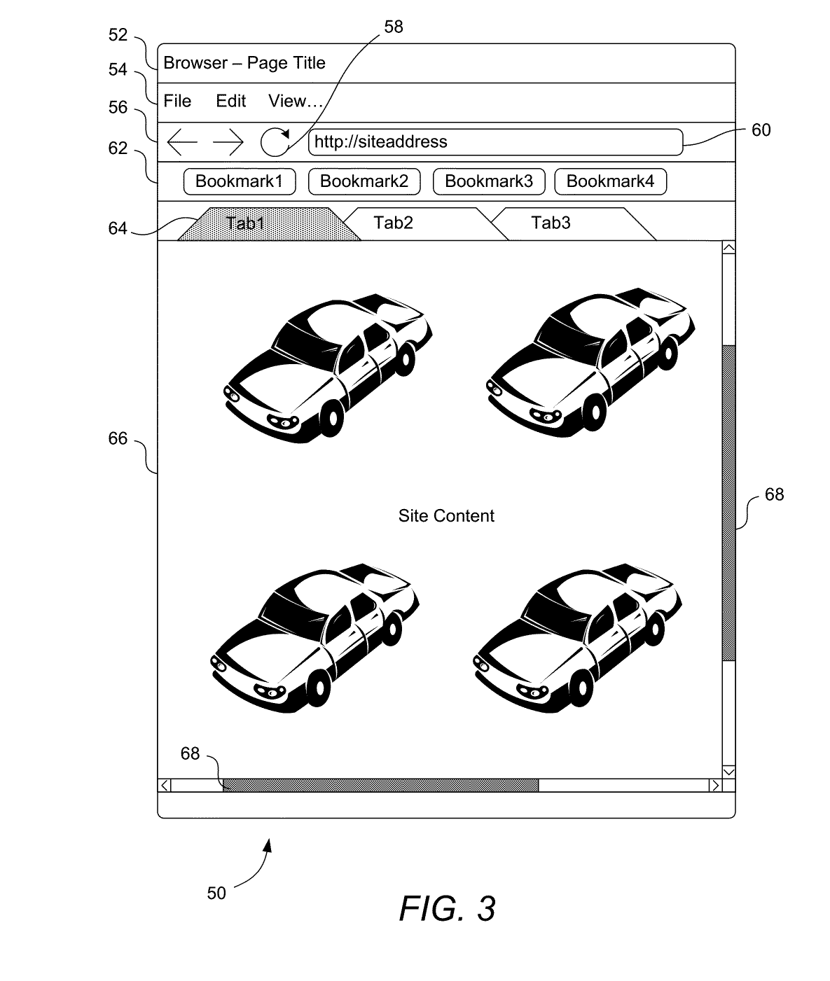

To minimize the need to download and/or install programs on users' computers, or for any other purpose discussed herein, embodiments of the invention utilize existing web browser technology. Many browser programs currently exist or are under development, and it would be impossible to name all such browser programs, but examples of such programs include Microsoft's Internet Explorer, Mozilla Firefox, Google Chrome, Apple Safari, Opera Software's Opera browser, as well as myriad browsers specifically configured for specific devices, such as Internet-connected smart phones and the like. While the exact display of each browser can vary from browser to browser and while most are moderately to highly configurable so as to vary the exact display, FIG. 3 shows a representative browser window 50 similar to what might be displayed on a user's computer device. It will be appreciated that many of the features described below with respect to the illustrated browser window 50 are optional or are optionally displayed or hidden as desired by the user, but each feature is typical or illustrative of features common to many browser programs.

The browser window 50 of FIG. 3 includes a title bar 52. The title bar 52 often is used to display a page name of whatever page is actively being viewed. Most commonly, the page name that is displayed is selected by the administrator of the website being viewed, and the page name often includes one or more phrases associated with the administrator of the website and/or the page being viewed. The browser window 50 also includes a menu bar 54 that includes items that may be selected to provide access to various menu functions, as is well known in the art. Of course, the menu functions provided in the menu bar 54 may vary according to the specific browser program, among other considerations, and access to menu functions may be provide other than by a menu bar similar to menu bar 54.

The browser window 50 of FIG. 3 also includes an address bar 56, which in the browser window 50 shown in FIG. 3 includes several browser controls 58 and an address entry area 60. The browser controls 58 and the address entry area 60 facilitate browsing using the window, permitting the user, for example, to go back one or more pages, to go forward one or more pages, to refresh a page, and/or to type in a destination site's address to directly access a page. Such browser features are well known in the art and need not be further discussed.

The browser window 50 also includes a bookmark bar 62 that a user can populate with bookmarks to commonly-accessed web pages, such that the user can quickly re-access the page(s) by clicking on the relevant bookmark button. In most common browser programs, it is possible for the user to have several different websites open simultaneously, and for the browser to provide rapid access, switching between, and management of the various open sites by way of various tabs 64, as shown in FIG. 3. Each tab 64 provides access to one open website. The tabs 64 facilitate navigation between different open websites. The contents of each open and actively-viewed website may be displayed in a content area 66. Thus, the content displayed in the content area 66 may vary depending on which tab 64 is selected, and which website is being viewed.

Whereas the tabs facilitate navigating between different websites, the browser window 50 optionally includes features to facilitate navigating within a website, as is known in the art. Specifically, the browser window may optionally include one or more scroll bars 68. When a portion of the website being viewed lies outside of the viewable portion of the content area 66, the user may use the scroll bars 68 to access non-visible portions, as is known in the art.

Many currently-available browser programs permit the installation of additional features, such as through what are commonly known as “browser extensions.” Browser extensions are becoming more and more common in today's browser programs, and have become one of if not the standard for extending the functionality of the browser programs. For browsers that do not currently support browser extensions, other mechanisms and installed programs are often available to provide similar functionality. Thus, functionality discussed herein as occurring using a browser could optionally be provided as a separate installed or installable program, including computer program instructions provided on a non-transitory computer-readable medium. Embodiments of the invention embrace all mechanisms for providing functionality such as that discussed herein.

Embodiments of the invention utilize a browser extension or similar format to provide functions in accordance with embodiments of the invention. The use and installation of a browser extension is typically significantly less involved and less computer-intensive than the use and installation of a stand-alone program. In many instances, the installation of the browser extension occurs essentially without the computer's operating system being made aware of any additional installation. Instead, the browser program itself handles the browser extension and any demands made by the browser extension.

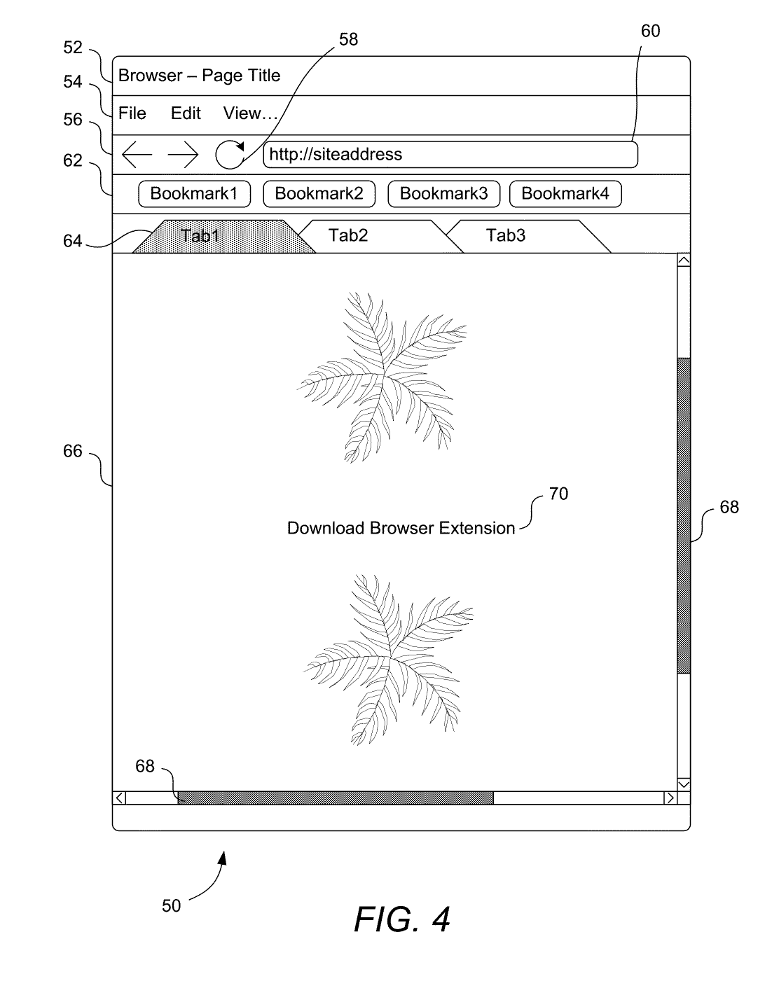

A browser extension in accordance with embodiments of the invention, for example, may be rapidly and easily installed, such as by visiting a download website. An example of such a website is shown in FIG. 4. A user desiring to obtain functionality associated with embodiments of the invention may visit a website such as that illustrated in FIG. 4, and may select an installation link 70. Upon selection of the installation link 70, the user may be prompted to confirm in one or more steps that he or she wishes to download and install the browser extension. If the user confirms that the browser extension is to be downloaded and installed, the download and installation is completed.

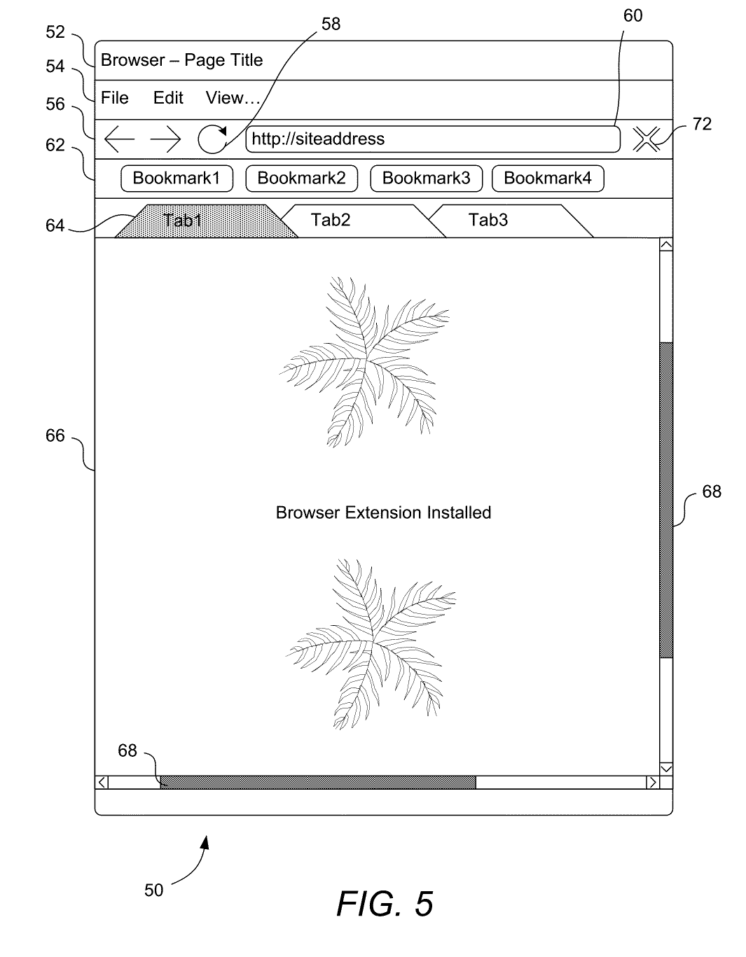

Access to the browser extension may be provided according to any method known in the art, but one example is shown in FIG. 5, in which it can be seen that a browser extension icon 72 has been added to the address bar 56. Of course, where an icon such as the browser extension icon 72 is provided, it may be provided at any desirable location or on any desirable toolbar, including a new toolbar, within the browser window 50. Additionally, features provided by the browser extension may alternatively be accessed by one or more menu functions accessed through a browser menu or any other similar mechanism, through one or more keystroke combinations, touchscreen inputs, or voice commands, as well as by any means or mechanism for accessing such functions now known in the art or later created.

Once the browser extension has been installed (which is a relatively easy process, as described above), the browser program and the browser extension may be used to provide functions in accordance with embodiments of the invention. While the specific functionality of the browser extension may be varied in essentially infinite ways while maintaining the functionality that will be discussed herein, including customizations for each user to facilitate each user's access, a description of illustrative ways in which that functionality may be utilized is given herein and in the attachments.

As outlined in more detail in the appendices, which are incorporated herein by reference, a game or competition may be provided using various computer systems, including networked computer systems. The computer systems may operate or implement computer program code for implementing methods as discussed herein and in the appendices. Embodiments of the invention encompass non-transitory computer-readable media containing such computer program code.

A system for social marketing may include a competition server operating computer program code for implementing a method that includes operating a game or competition, wherein the game or competition involves a plurality of participants, and wherein operating the game or competition includes receipt of an entry action from each of the participants, indicating entry into the game or competition; initiating a countdown for each participant, the countdown indicating a deadline by which a further action must be taken by each participant to remain in the game or competition; receipt of the further action from at least one of the participants, indicating the participant's desire to remain in the game or competition; initiating a new countdown for each participant from whom the further action was received, the new countdown indicating a new deadline by which an action must be taken to remain in the game or competition; receipt of the action selected from the group of the further action and the new further action from at least one of the participants; and repeating the steps of initiating a new countdown and receipt of the action selected from the group of the further action and the new further action until a number of remaining participants equals a number of available prizes for the game or competition. The system may electronically deliver marketing to the participants while the game is being operated.

An alternative system for social marketing may include a competition server operating computer program code for implementing a method that includes operating a game or competition, wherein the game or competition involves a plurality of participants, and wherein operating the game or competition includes receipt of an entry action from each of the participants, indicating entry into the game or competition; initiating a countdown for each participant, the countdown indicating a deadline by which a further action must be taken by each participant to remain in the game or competition; receipt of the further action from at least one of the participants, indicating the participant's desire to remain in the game or competition; initiating a new countdown for each participant from whom the further action was received, the new countdown indicating a new deadline by which an action must be taken to remain in the game or competition; receipt of the action selected from the group of the further action and the new further action from at least one of the participants; receipt of an action to purchase one of the available prizes at a current offer level; and repeating the steps of initiating a new countdown and receipt of the action selected from the group of the further action and the new further action until a number of available prizes for the game or competition is exhausted. The system may electronically deliver marketing to the participants while the game is being operated.

The competition server may receive actions from the participants over a computer network, including over the Internet. Operating the game or competition may include, in conjunction with the step of repeating the steps of initiating a new countdown and receipt of the action selected from the group of the further action and the new further action until a number of remaining participants equals a number of available prizes for the game or competition: evaluating whether the new countdown should be made shorter than an immediately previous countdown; when the new countdown should be made shorter than the immediately previous countdown, making the new countdown shorter than the immediately previous countdown; and when the new countdown should not be made shorter than the immediately previous countdown, making the new countdown the same as the immediately previous countdown.

Electronically delivering marketing to the participants while the game is being operated may include varying the marketing delivered to the participants as a function of a game or competition progress measure, the progress measure being selected from the group of: an amount of time that has passed since initiation of the game or competition; a rate of change in a number of participants remaining in the game or competition; a number of participants remaining in the game or competition; and a length of the new countdown.

Marketing through competition according to the concepts discussed herein leverages the benefits of social media to allow companies to target their advertising in untapped ways. The marketing methods discussed herein serve as an additional marketing mechanism that can work hand in hand with existing marketing methods. Methods as discussed herein can appeal to and attract customers of a specific interest or behavior rather than reaching out to a broadly defined demographic. Characteristics that can be targeted include age group, gender, geography, and the like. Users may be exposed to product and service information, and may be exposed to location-based and time-sensitive promotions. Users may obtain access to money-saving coupons and group-buying discounts as well as building price concessions.

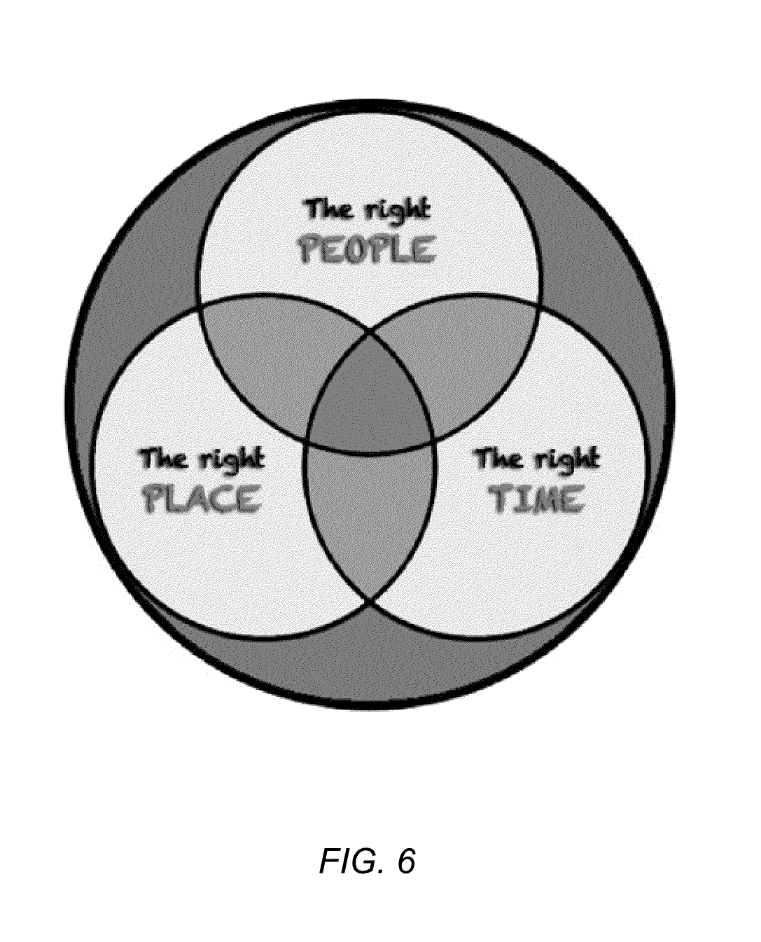

While many advertisers have taken advantage of the often-lower costs of online advertising, the truth is that such advertising is often woeful at reaching target customers: those who are not only most interested in the goods or services being offered, but those most likely to buy those goods or services. Thus, as illustrated in FIG. 6, better results are achieved through embodiments of the invention as advertising is directed to the right people at the right place at the right time, and this largely through self-selection by the advertising targets. First, the competition-based advertising methods are effective at attracting the right people at the right time—those most interested in the product or service. This initial attraction may occur through some initial advertising, but may often occur simply by word-of-mouth and other social means: one person who becomes aware of a competition makes others aware of the competition. As may be appreciated, those who are most interested in competing for a free or reduced-price product or service are often likely to know others interested in a similar opportunity.

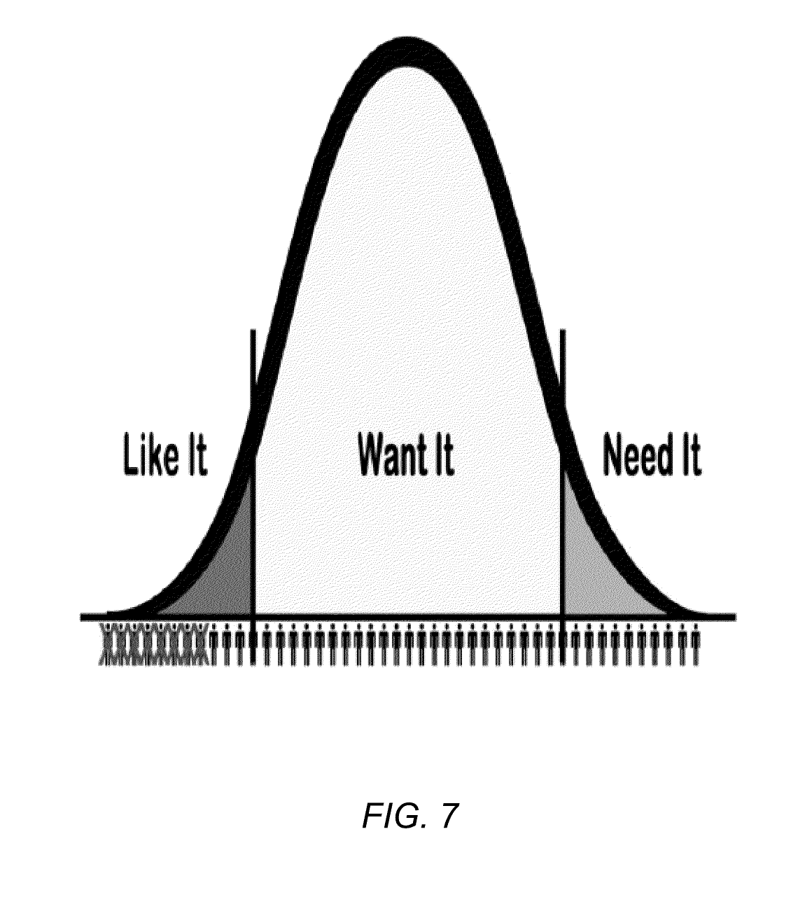

As may be further appreciated, those who self-select to not only initially participate in a competition to obtain a free or reduced-price product or service, but to continue participating in a competition to achieve the free or reduced-price product or service tend to be those with the most interest in the product or service. With existing advertising methods, much advertising effort is wasted and directed to portions of the market that are unlikely to purchase a product. For example, when considering a normal bell curve of potential customers that might be reached by an advertising campaign, as is illustrated in FIG. 7, some percentage might like the product or service, but not really want the product or service. A significant majority might want the product or service, but not sufficiently to justify, in most of the majority's mind, a purchase of the product or service. Meanwhile, a small minority might actually have a need for the product or service, and would probably buy the product or service almost regardless, as long as the consumers are aware of its existence.

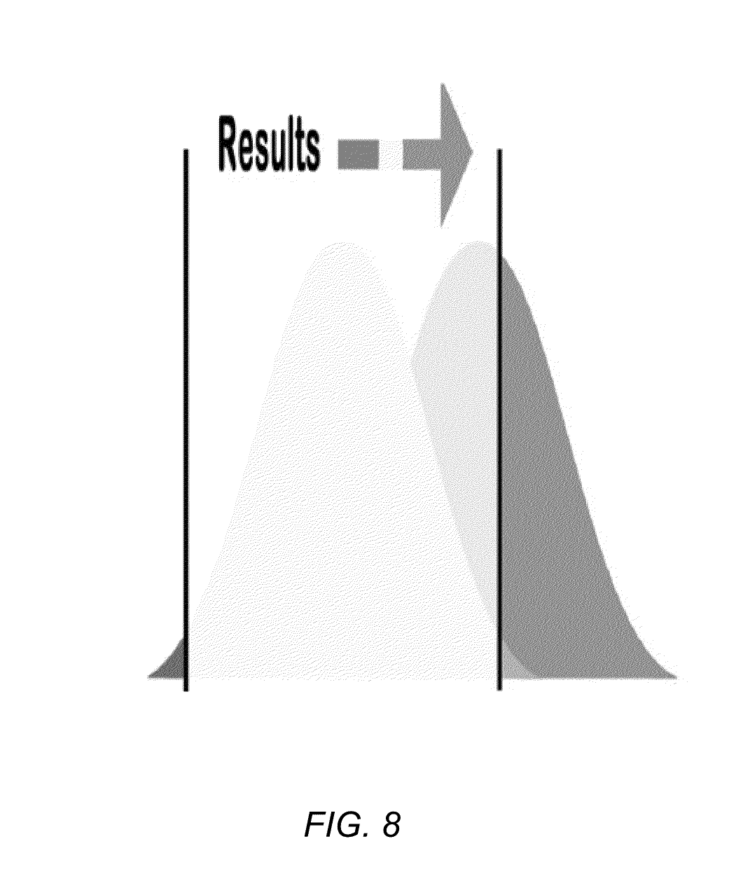

Methods according to embodiments of the invention effectively push the bell curve of those to whom the advertising is directed to the left so that advertising largely reaches those who need a product or service and those who want the product or service and are most likely to make a discretionary purchase of the product. As seen in FIG. 8, the methods push the bell curve to the right, and make the advertising much more effective, because it is targeted to the portion of consumers most likely to proceed with a purchase immediately and in the future, and those consumers largely select themselves and voluntarily expose themselves to the marketing efforts.

Businesses advertising using the competition marketing system are able to craft their competitions to achieve desired results. They may select the product(s) and service(s) available for a competition, and may control a wide variety of aspects of the competition. The system may make certain suggestions relating the competition, such as suggestions relating to discounts, time of the competition, and a variety of other features relating to the competition, but the business may remain free to accept or reject suggestions provided by the system. In certain embodiments, the business may be limited in certain regards to ensure that the competition comports with standard competition format.

Competitions may be geographically targeted. Business that rely largely on local clientele may not wish to essentially waste money on advertising reaching customers who are geographically unlikely to purchase from the business. For example, a business offering services locally need not worry about advertising outside the local geographic area. As another example, businesses offering consumables such as restaurants generally prefer that their advertising efforts be directed geographically to local consumers, as such consumers are more likely to become customers of the businesses. Embodiments of the invention allow business to direct their competitions to local markets, and allow individual users to seek geographically local competitions in which to participate.

Examples of concepts underlying embodiments of the invention may help to illustrate the features of a competition in accordance with embodiments of the invention, reasoning behind structuring a competition in the manner disclosed herein, and the result of such competition structure. For example and as a means to illustrate the concept, consider a local event. As people are leaving at the conclusion, it is announced over a loudspeaker that a Cadillac Escalade will shortly be arriving center stage. Further, it is mentioned that for anyone interested in taking this award-winning vehicle home 100% for free, participants may register and sign up to win, as a competition will begin momentarily.

As it is announced, the Cadillac is brought out for all to admire, and as is expected, a growing group of people begins to crowd around, admiring the vehicle and beginning to dream of how amazing it would be to take it home. Moreover, as people see the vehicle and read about the particulars, for some a Cadillac Escalade isn't even an interest for one reason or another. For example, some in the crowd may say it is obnoxiously impractical as they think to themselves I couldn't even afford to maintain, albeit it for free, between the taxes, the added expense of insurance, fuel, ongoing maintenance, etc. and thus they opt not to participate. Likewise, there may be others who dislike Cadillac and the image it portrays and thus decided to move on without participating.

However and on the contrary, there will undoubtedly be others who would love to drive this vehicle home for any number of a lot of reasons and the crowd begins to grow to a very large level. At this point the onlookers begin to ask how it works and the people present are given the simple instructions. In short, anyone who wants to win this vehicle must simply place his or her hand upon it, and he or she who successively keeps their hand in constant contact the longest wins! It's a simple game of persistence and it is anticipated, for sakes of competition, that the participant who wants it the most, is willing the play the longest and forego any number of other alternative time-consuming options of life during the competition will ultimately win this prize. In life there are recurring tradeoffs with everything we choose to do, so true it is in the competition. Unlike the lottery or the common raffle where a participant's fate is left to chance, in this game play format, when to be eliminated is entirely left up to each competitor, their personal interest crossed to that of their motivation and desire to win vs. the tradeoff of whatever else they could be doing—or in other words the opportunity cost of participating.

Seemingly, most everyone is interested, especially in the beginning, and albeit a few who decide to depart for any number of personal reasons, people become excited at their chances of winning as they anticipate the start of the competition. In fact, it is likely that many participants subconsciously will begin to formulate a plan or strategy with hopes of bettering their chances. Further, as the workers of the competition are taking down the names of the contestants for verification purposes and answering additional questions from the group, our crowd naturally begins to grow. You see, it is anticipated that this type of giveaway will spread quickly as people call friends excitedly to tell them they are about to win a Cadillac Escalade and this ongoing social commotion will only add to the number of interested participants by the power of social networks and instant word-of-mouth advertising! It is this power of personal peer-to-peer social marketing that is harnessed and monetized through the various system and tools discussed herein.

As the contestants begin to play, everyone positions themselves somewhere where they can touch the SUV and in the beginning the sum of all our interested challengers and their hands cover our vehicle from top to bottom for their individual chance at winning. In the online system discussed herein the actual competition is a virtual or online one, or one conducted virtually from a computer or other supporting application with access to the Internet. Hence, as many people as desire to sign up and play any number of ongoing competitions within the system being offered can participate without space limitations. In short, in the computer world, space is not limiting and games can accommodate thousands, hundreds of thousands and even millions of interested contestants from all over the world and from anywhere they might connect. However, for sake of the Cadillac Escalade example and to illustrate the competition in simple terms, assume there are 100 individuals standing around when the competition begins and likewise, 100 hands are placed upon the Cadillac Escalade.

Assume as the competition begins that we are able to peer inside each participant's mind, hear their thoughts and gauge their interest and enthusiasm as the gameplay proceeds forward. Theoretically in this make-believe scenario we would hypothetically be able to determine of our 100 contestants playing this particular competition, those challengers who are partially interested, others who are more interested and obviously those who are the most interested in winning among the group. Similarly then, for our example, it is safe to assume that each of our players has a personal commitment to winning this particular item that is different to that of each of the others playing for any number of reasons.

Theoretically based upon our conclusions above, each participant's engagement level varies and each participant's desire to win is unique to them for any number of personal biases and tradeoffs. The 100 participants could be lined up from left to right based upon their overall intrinsic motivation and commitment to winning, starting with he or she who is the least interested to the very far left and he or she who is the very most interested to the very far right. Seemingly, as the competition plays out, it is believable that the participants with the least interest, all to the left with less overall intrinsic motivation and commitment to winning will be more likely to retire or quit prior to the participants to the right who intrinsically want to win our item the more.

Additionally, it is predicted out of the group of 100 systematically lined up from left to right based upon their intrinsic motivation and commitment to winning any particular competition, or in other words when considering this particular item, that this group would fall well under the concept of the statistical standard deviation. Moreover, taking the 100 contestants lined up left to right as outlined below then choosing to draw the standard bell curve above our group of competitors and consequently aligning the ordinary one standard deviation markers on said diagram, one on the left and the other to the right, thus dividing our group into three distinguishable subgroups.

To simplify this analytical concept below, out of the group of 100, roughly ten participants, or approximately ten percent, will fall within a subgroup to the left, considered the outliers who are the least intrinsically interested. Similarly, we would have another subgroup of roughly ten participants, or another ten percent of the total group of competitors for the Cadillac Escalade to the right, this time considered the outliers who are the most intrinsically interested in winning the prize. Lastly and by common mathematical and statistical deduction, we can ascertain that roughly eighty participants, or approximately eighty percent of the participants for this particular prize align in the middle subgroup, falling between those on the left and the others to the right.

Those participants on the left may be classified as the ones who “Would like the prize” and for the subgroup in the middle, those who “Want the prize” and for the subgroup to the right, the ones who “Need the prize.” See FIG. 7. While there are likely numberless reasons of why participants fall into one particular group over another, however the common principle is again derived from both their personal and intrinsic motivation and commitment to winning the product or service up for grabs. Predictably however, once which subgroup a participant falls within has been identified, some suppositions can be made about them in relation to the item they are playing for.

The far left group typically plays because it is free (should they win) and at a price of free they would take it. The middle group typically plays because they are curiously and for the most part sincerely interested in learning more about and likely would eventually enjoy owning the zwittle product or service. The far right group typically is playing because they have done research already, know what the features and benefits are, sincerely want this item and solely have not come to the point of transacting yet there are the typical fence sitter.

At the moment a participant puts forward effort to register for a particular competition, either they themselves or someone they personally know is inherently interested in owning said item as demonstrated by their effort of action. Further, once said participant checks in for the game, which may come at a later date in time, it is safe to assume they admittedly agree that their interest to own this particular product or service inherently falls somewhere between receiving it free (winning) and a wiliness to purchase it at the price currently and commonly available on the open market. The participant, by taking action and extending documented effort essentially admits to interest in the product or service that falls somewhere between free and current open market pricing, which can be evaluated through an evaluation of their participation in the competition.

Eventually, as the gameplay continues forward, participants begin to be eliminated for any number of reasons including but not limited to the following: participants may have other responsibilities they must attend to, participants may become distracted and unfortunately lose out, participants, through playing, learning and researching lose interest and is eliminated, participants, through playing, learning, researching and the additional exposure the competition gameplay provides become determined that they must obtain the particular product or service and moves forward comfortably with making a purchase at whatever price is currently available (either through the competition or otherwise).

Theoretically, throughout the game there is an ongoing conscious tradeoff for each competitor, seemingly the opportunity cost of continuing in the game vs. all that they could otherwise be doing with their time. Ultimately and systematically with obvious exceptions, those participants that are less interested and or are not as intrinsically motivated and committed to winning as others in the competition for our prize tend to be eliminated sooner than the participants who are determined to own the prize. Finally, the gameplay ends when all participants are eliminated but one final challenger, he or she who is evidently and passionately interested and tremendously motivated and committed in winning for any number of reasons, competing above and beyond any other. Alternatively, the gameplay ends when a cost to obtain a number of available prizes becomes low enough that competitors opt to purchase at the reduced price, using up the available prizes.

Logically, as the end of the competition approaches, more participants from the “I need it!” group remain than from the other two. Some participants may through the very process of participating and engaging in the competition, shift from their beginning position as they are exposed to product or service features and benefits, advancing along the bell curve from a more leftward position to a newer position now further to the right as demonstrated in FIG. 8, wherein the actual bell curve shifts entirely from its origination to a position upon conclusion more to the right, demonstrating the positive effects of the marketing system and its creative, fun and engaging way of amplifying awareness, boosting loyalty and creating results!

The participants, by design, are almost a perfect representation of exactly the desired target market for a particular product or service, strategically brought together from curiosity, voluntarily acknowledging interest, willingly trading alternative opportunity costs to compete for, learn about and be marketed to throughout the process of competing to win a identified item of interest. This group of gameplay participants is the exact group that companies around the globe pay millions of dollars trying to identify, learn about and market to. This group is by design the desired target market, captivated by the process of playing to win, fascinated by the thought of possessing and motivated by the desire of prevailing victorious. It is this very group who are questioning to learn more, interested in owning and most likely the ones who, with proficient marketing, will become eventual purchasers someday.

The gameplay can be enhanced with bonuses that serve as a bonus to both participants and product or service sponsors. A bonus calls to action participants to exert effort at selected times throughout the competition, as noted by the business sponsor, to do something in order to receive some type of bonus, be it extra time on their play clock or a voucher to receive something of value. Bonuses may be related to the reality of online gameplay, where, unlike keeping one's hand on a prize in real life, when the game is started, each participant has an active countdown game clock with time that is expiring. Further, next to each expiring play clock is a button, which when selected will reset the player's play clock.

For example, suppose a player registers to compete for a competition of interest that is set to start Monday morning at 8:00 am. Monday morning at 8:00 am when this player logs into the system and goes to the registered gameplay, there is a checkin prerequisite to enter the actual game and a specified time assigned to complete this requirement. Upon checking in a countdown timer begins and once it reaches 0:00 (8:00 am) this competition goes live. Any participant failing to checkin is automatically eliminated while all other players that completed this initial task see a play clock counting down from some gameplay designated time allotment, such as thirty minutes. Consequently, so long as the player continues to select the game clock button prior to the thirty minutes expiring, they remain to be part of the active participants in the running to win this competition. However, should they become distracted or fail to log back into the system with sufficient time to reset their gameplay clock, such that the clock is left to expire, they are eliminated from the competition. This is the equivalent of removing their hand from the Cadillac Escalade example outlined above.

As the competition continues and as mentioned above, periodically a bonus may pop up or otherwise become available requesting a player watch a video and receive a voucher for a percentage off products offered by the vendor or other business sponsoring the competition. Another even more powerful example is when there are only a select number of participants playing and these participants have been waking up throughout the night for weeks now to reset their clock, the bonus may invite them to visit a particular location, go through a sales presentation or something of the like for a code that when input into the system will grant the participant a one-time extension upon their game clock well past that of thirty minutes. Imagine waking up every thirty minutes throughout the night and for the past ten nights, but tonight, if the competitor visits a local establishment and goes on a facility tour, the competitor will receive a fifteen hour reset bonus. Many participants will take advantage of this bonus.

Moreover, for businesses sponsoring the zwittle, such a bonus can be very powerful. For example, a facility that plays host to wedding events might have a track record of closing on ninety percent of potential brides that come for a walk-through visit. A visit from the most intrinsically motivated and committed competitor brides-to-be delivers results and allows businesses to leverage their most powerful current market strategies to increased numbers of potential customers. As an example, as the game continues to play, little by little, competitors are eliminated and while each one is subsequently thanked for participating and offered a personalized voucher discount should they like to “buy now,” the remaining participants continue to compete for the prize. Wherein at some point in the gameplay selected by the business, a bonus pops up with a message encouraging the participant to take further action to obtain a competition bonus. Such actions may include actions taken online as well as in person, such as watching a promotional video, taking a quiz designed to increase the participant's knowledge of and engagement with a product or service, visiting the business in person, and the like.

The gameplay model is, by its very design, bringing together buyers and sellers by leveraging technology and common human nature, making for an exciting and informative way to reach one another and transact together. This exercise can thus be exploited in many ways to drive advertising opportunities and top-line revenue.

As is illustrated in additional detail in the various illustrative screenshots and further discussion contained in the attached Appendices, various informational incentives may be provided to incentivize continued engagement by the contest participants. For example, the user may be informed in a variety of ways of the number of participants in the competition. As one example, a status bar might show the user the number of remaining participants. As another example, the user may simply be told how many participants remain. As the number of participants dwindles, the user will accordingly be incentivized to continue his or her participation, as he or she sees her progress in the competition.

As another example, a feature of the competition may be a decreasing price of the available prizes as the competition goes on. For example, ten prizes are available at full retail price at the start of the competition. As the competition progresses, the price of the available prizes may decrease over time. As the price decreases, the price may reach a point where one participant wishes to purchase the product rather than continue participating to obtain a lower price. Any purchase below a certain price may reduce the number of prizes available accordingly. As other participants view the number of available prizes decreasing, they will be incentivized to also consider purchasing the prize at the currently available price, and their consideration of the product or service and its features will likely increase. In such an example, when all available prizes are purchased, the competition may immediately end.

Additional features and benefits of embodiments of the invention may be readily discerned by reference to the attached Appendices and by the practice of the invention.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A system for social marketing comprising:
a competition server operating computer program code for implementing a method comprising:
operating a game or competition, wherein the game or competition involves a plurality of participants, and wherein operating the game or competition comprises:
receipt of an entry action from each of the participants, indicating entry into the game or competition;
initiating a countdown for each participant, the countdown indicating a deadline by which a further action must be taken by each participant to remain in the game or competition;
receipt of the further action from at least one of the participants, indicating the participant's desire to remain in the game or competition;
initiating a new countdown for each participant from whom the further action was received, the new countdown indicating a new deadline by which an action must be taken to remain in the game or competition;
receipt of the action selected from the group of the further action and the new further action from at least one of the participants; and
repeating the steps of initiating a new countdown and receipt of the action selected from the group of the further action and the new further action until a condition occurs selected from the group consisting of:
a number of remaining participants equals a number of available prizes for the game or competition; and
a number of available prizes has been purchased out of the competition at then-available prices; and
electronically delivering marketing to the participants while the game is being operated.

2. A system as recited in claim 1, wherein the competition server receives actions from the participants over a computer network.

3. A system as recited in claim 1, wherein the competition server receives actions from the participants over the Internet.

4. A system as recited in claim 1, wherein operating the game or competition further comprises, in conjunction with the step of repeating the steps of initiating a new countdown and receipt of the action selected from the group of the further action and the new further action until a number of remaining participants equals a number of available prizes for the game or competition:
evaluating whether the new countdown should be made shorter than an immediately previous countdown;
when the new countdown should be made shorter than the immediately previous countdown, making the new countdown shorter than the immediately previous countdown; and
when the new countdown should not be made shorter than the immediately previous countdown, making the new countdown the same as the immediately previous countdown.

5. A system as recited in claim 4, wherein electronically delivering marketing to the participants while the game is being operated comprises varying the marketing delivered to the participants as a function of a game or competition progress measure, the progress measure being selected from the group of:
an amount of time that has passed since initiation of the game or competition;
a rate of change in a number of participants remaining in the game or competition;
a number of participants remaining in the game or competition; and
a length of the new countdown.

6. A non-transitory computer-readable medium storing computer program code for implementing a method comprising:
operating a game or competition, wherein the game or competition involves a plurality of participants, and wherein operating the game or competition comprises:
receipt of an entry action from each of the participants, indicating entry into the game or competition;
initiating a countdown for each participant, the countdown indicating a deadline by which a further action must be taken by each participant to remain in the game or competition;
receipt of the further action from at least one of the participants, indicating the participant's desire to remain in the game or competition;
initiating a new countdown for each participant from whom the further action was received, the new countdown indicating a new deadline by which an action must be taken to remain in the game or competition;
receipt of the action selected from the group of the further action and the new further action from at least one of the participants; and
repeating the steps of initiating a new countdown and receipt of the action selected from the group of the further action and the new further action until a condition occurs selected from the group consisting of:
a number of remaining participants equals a number of available prizes for the game or competition; and
a number of available prizes has been purchased out of the competition at then-available prices; and
electronically delivering marketing to the participants while the game is being operated.

7. A non-transitory computer-readable medium as recited in claim 6, wherein actions are received from the participants over a computer network.

8. A non-transitory computer-readable medium as recited in claim 6, wherein actions are received from the participants over the Internet.

9. A non-transitory computer-readable medium as recited in claim 6, wherein operating the game or competition further comprises, in conjunction with the step of repeating the steps of initiating a new countdown and receipt of the action selected from the group of the further action and the new further action until a number of remaining participants equals a number of available prizes for the game or competition:
evaluating whether the new countdown should be made shorter than an immediately previous countdown;
when the new countdown should be made shorter than the immediately previous countdown, making the new countdown shorter than the immediately previous countdown; and
when the new countdown should not be made shorter than the immediately previous countdown, making the new countdown the same as the immediately previous countdown.

10. A non-transitory computer-readable medium as recited in claim 9, wherein electronically delivering marketing to the participants while the game is being operated comprises varying the marketing delivered to the participants as a function of a game or competition progress measure, the progress measure being selected from the group of:
an amount of time that has passed since initiation of the game or competition;
a rate of change in a number of participants remaining in the game or competition;
a number of participants remaining in the game or competition; and
a length of the new countdown.

11. A method for social marketing comprising:
operating a game or competition, wherein the game or competition involves a plurality of participants, and wherein operating the game or competition comprises:
receipt of an entry action from each of the participants, indicating entry into the game or competition;
initiating a countdown for each participant, the countdown indicating a deadline by which a further action must be taken by each participant to remain in the game or competition;
receipt of the further action from at least one of the participants, indicating the participant's desire to remain in the game or competition;
initiating a new countdown for each participant from whom the further action was received, the new countdown indicating a new deadline by which an action must be taken to remain in the game or competition;
receipt of the action selected from the group of the further action and the new further action from at least one of the participants; and
repeating the steps of initiating a new countdown and receipt of the action selected from the group of the further action and the new further action until a condition occurs selected from the group consisting of:
a number of remaining participants equals a number of available prizes for the game or competition; and
a number of available prizes has been purchased out of the competition at then-available prices; and
electronically delivering marketing to the participants while the game is being operated.

12. A method as recited in claim 11, wherein the competition server receives actions from the participants over a computer network.

13. A method as recited in claim 11, wherein the competition server receives actions from the participants over the Internet.

14. A method as recited in claim 1, wherein operating the game or competition further comprises, in conjunction with the step of repeating the steps of initiating a new countdown and receipt of the action selected from the group of the further action and the new further action until a number of remaining participants equals a number of available prizes for the game or competition:
evaluating whether the new countdown should be made shorter than an immediately previous countdown;
when the new countdown should be made shorter than the immediately previous countdown, making the new countdown shorter than the immediately previous countdown; and
when the new countdown should not be made shorter than the immediately previous countdown, making the new countdown the same as the immediately previous countdown.

15. A method as recited in claim 14, wherein electronically delivering marketing to the participants while the game is being operated comprises varying the marketing delivered to the participants as a function of a game or competition progress measure, the progress measure being selected from the group of:
an amount of time that has passed since initiation of the game or competition;
a rate of change in a number of participants remaining in the game or competition;
a number of participants remaining in the game or competition; and
a length of the new countdown.
